(19) United States
(12) Patent Application Publication
(10) Pub. No.: US 2024/0383112 A1
(43) Pub. Date: Nov. 21, 2024

(54) Hex Wrench Structure

(71) Applicant: Chang-Yu Tsai, Taichung City (TW)

(72) Inventor: Chang-Yu Tsai, Taichung City (TW)

(21) Appl. No.: 18/320,283

(22) Filed: May 19, 2023

(51) Int. Cl. B25B 23/10; B25B 15/00

(52) U.S. Cl. CPC B25B 23/108; B25B 15/008

(57) ABSTRACT

A hex wrench structure includes a main body and a laser body. An operation end is provided on the main body. The operation end has six faces and an end face. The six faces surround the end face. The operation end is provided with a chamfered corner located between the six faces and the end face. The operation end is provided with an axis. The six faces are arranged in an annular shape around the axis. The laser body is formed on a whole surface or a partial surface of the operation end by a working machine during a laser process. The whole surface or partial surface of the operation end is provided with a friction face formed by the laser process. The friction face increases a contact friction force between the operation end and the workpiece.

### BACKGROUND OF THE INVENTION

### Field of the Invention

The present invention relates to a hand tool and, more particularly, to a hex wrench structure.

### Description of the Related Art

A conventional hand tool was disclosed in the U.S. Pat. No. 8,020,473, and comprises a main body 10, at least one second body 20, and a cover 40. The main body 10 is a handle and is provided with at least one slot 11 and an opening 111. The at least one second body 20 is mounted in the at least one slot 11 and is provided with a grinding face 21. The cover 40 seals the at least one second body 20 in the at least one slot 11. When the main body 10 contacts an oily liquid, such as engine oil, lubricating oil, etc., in the workplace, the main body 10 easily slips from the workpiece, thereby causing inconvenience to the operator. The grinding face 21 provides an anti-slip function to increase the friction between the main body 10 and the workpiece so that the main body 10 will not slip from the workpiece during operation. However, the grinding face 21 only provides an anti-slip function and cannot increase the function of the main body 10, thereby limiting the versatility of the hand tool.

### BRIEF SUMMARY OF THE INVENTION

In accordance with the present invention, there is provided a hex wrench structure comprising a main body and a laser body. An operation end is provided on the main body. The operation end is provided with six faces. The operation end is provided with an end face. The six faces surround the end face. The operation end of the main body is provided with a chamfered corner. The chamfered corner is located between the six faces and the end face. The operation end is provided with an axis. The six faces are arranged in an annular shape around the axis. The laser body is mounted on the operation end. The laser body is formed on a whole surface or a partial surface of the operation end by a working machine during a laser process. A laser light is applied on the operation end. The whole surface or partial surface of the operation end is provided with a friction face formed by the laser process. The friction face is a rough surface with particles. The friction face increases a contact friction force between the operation end and the workpiece to prevent the workpiece from slipping from the operation end.

According to the primary advantages of the present invention, the friction face increases the friction force between the operation end and the workpiece when contacting, to prevent the workpiece from slipping from the operation end. The surface of the operation end is provided with the laser body with the friction face. When the workpiece produces burrs, the laser body on the main body is used as a grinding tool to remove the burrs on the workpiece without having to use or purchase a sander, thereby saving the working time.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a hex wrench structure in accordance with the first preferred embodiment of the present invention.

FIG. 2 is a top view of the hex wrench structure as shown in FIG. 1.

FIG. 3 is a locally enlarged view of the hex wrench structure taken along circle A as shown in FIG. 2.

FIG. 4 is a perspective view of a hex wrench structure in accordance with the second preferred embodiment of the present invention.

FIG. 5 is a locally enlarged view of the hex wrench structure taken along circle B as shown in FIG. 4.

FIG. 6 is a perspective view of a hex wrench structure in accordance with the third preferred embodiment of the present invention.

FIG. 7 is a perspective view of a hex wrench structure in accordance with the fourth preferred embodiment of the present invention.

### DETAILED DESCRIPTION OF THE INVENTION

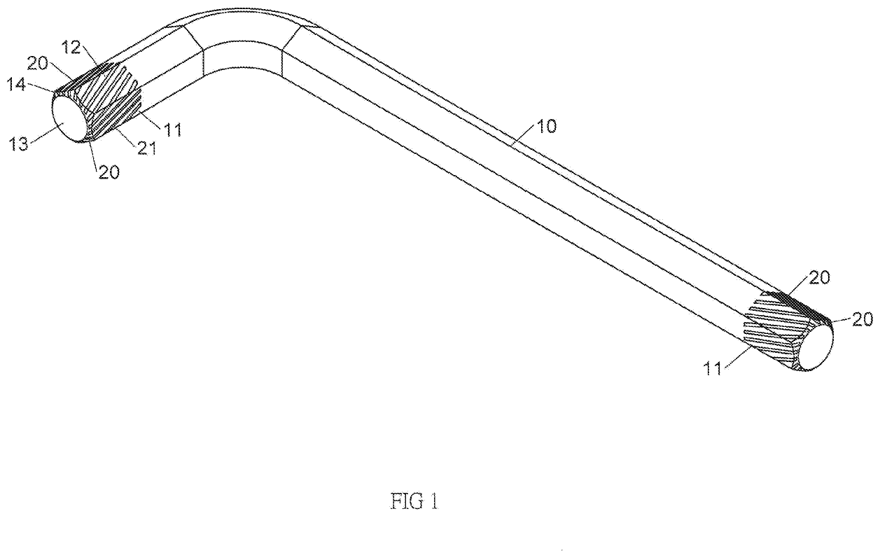

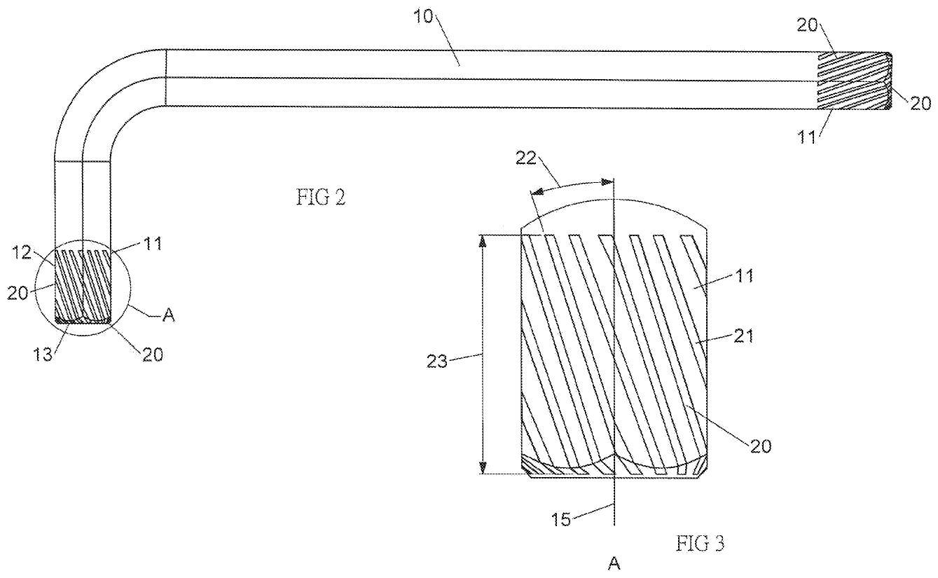

Referring to the drawings and initially to FIGS. 1-3, a hex wrench structure in accordance with the preferred embodiment of the present invention comprises a main body 10 and a laser body 20 mounted on the main body 10.

The main body 10 has an L-shaped profile. An operation end (or an active end or a working end) 11 is provided on at least one end of the main body 10. Preferably, the operation end 11 is provided on two ends of the main body 10. The operation end 11 is a surface contacting another element. The operation end 11 is a surface contacting a workpiece. The operation end 11 is a surface for rotating a workpiece. The operation end 11 is provided with six faces 12. Each of the six faces 12 has a planar shape. The operation end 11 is provided with an end face 13. The six faces 12 surround the end face 13. The end face 13 has a planar shape. The operation end 11 of the main body 10 is provided with a chamfered corner 14. The chamfered corner 14 is located between the six faces 12 and the end face 13. The chamfered corner 14 has a circular shape. The operation end 11 is provided with an axis 15. The six faces 12 are arranged in an annular shape around the axis 15.

The laser body 20 is mounted on the operation end 11. The laser body 20 is formed on a whole surface or a partial surface of the operation end 11 by a working machine during a laser process. A laser light is applied on the operation end 11. The whole surface or partial surface of the operation end 11 is provided with a friction face 21 formed by the laser process, including peeling, coloring, concentration, or carbonization. The friction face 21 is a rough surface with particles. The friction face 21 increases a contact friction force between the operation end 11 and the workpiece to prevent the workpiece from slipping from the operation end 11.

The laser process includes diverse methods and will not be described in detail. The operation end 11 is provided with the laser body 20, and the friction face 21 of the laser body 20 is formed by the laser process.

The laser body 20 is provided on a surface of the operation end 11. The friction face 21 is served as the surface of the operation end 11. The friction face 21 covers at least one third (⅓) of the surface of the operation end 11.

Multiple friction faces 21 are provided on the partial surface of the operation end 11. The friction faces 21 are arranged on a partial surface of the six faces 12. The friction faces 21 are arranged on a partial surface of the chamfered corner 14. The friction faces 21 are arranged in an annular shape around the axis 15. The end face 13 is not provided with the friction faces 21.

The friction faces 21 are arranged obliquely relative to the operation end 11. An angle 22 is defined between each of the friction faces 21 and the axis 15. The angle 22 is ranged between ten (10) degrees and seventy (70) degrees, or ranged between fifteen (15) degrees and sixty (60) degrees. The angle 22 is optimally close to thirty (30) degrees. Each of the friction faces 21 has a size 23 relative to the operation end 11. The size 23 is a length perpendicular to the axis 15. The size 23 is more than ten millimeters (10 mm) or twelve millimeters (12 mm).

Alternatively, the friction faces 21 are arranged linearly relative to the axis 15 so that the friction faces 21 and the axis 15 are parallel mutually. Alternatively, the friction faces 21 are arranged transversely relative to the axis 15 so that the friction faces 21 surround the axis 15 and are arranged linearly in a direction of the axis 15.

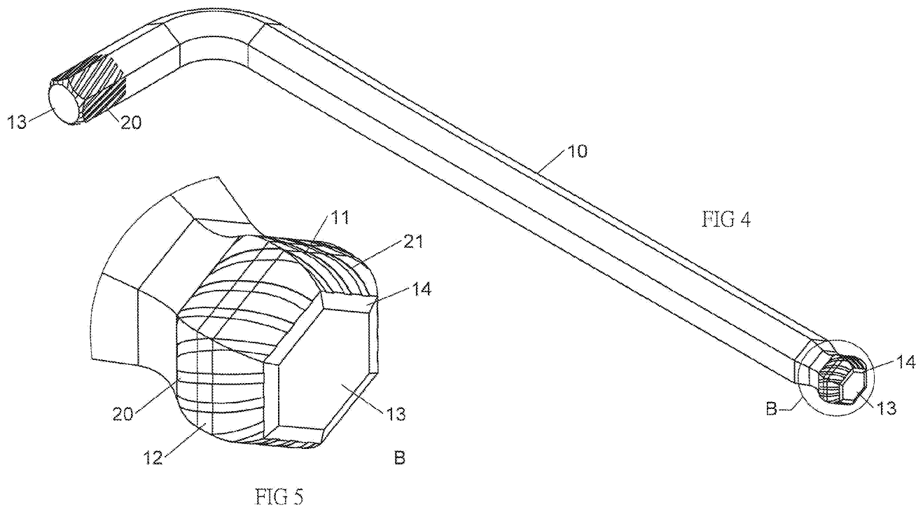

Referring to FIGS. 4 and 5, each of the six faces 12 of the operation end 11 on one of the two ends of the main body 10 has a planar shape, and each of the six faces 12 of the operation end 11 on the other one of the two ends of the main body 10 is a convex face having a planar middle so that each of the six faces 12 includes a first arcuate face connecting a plane connecting a second arcuate face. The chamfered corner 14 has an oblique shape.

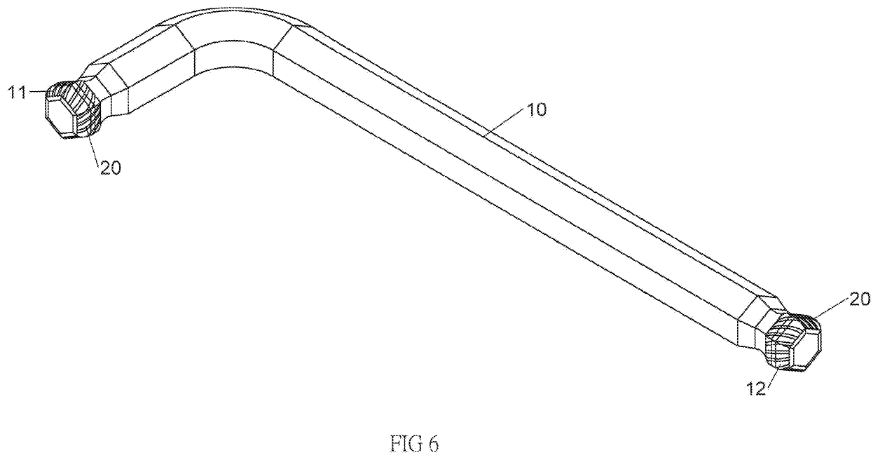

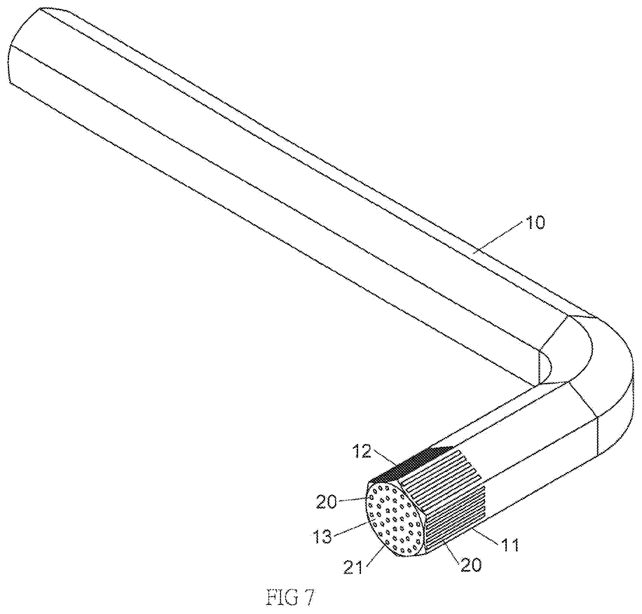

Referring to FIG. 6, each of the six faces 12 of the operation end 11 on each of the two ends of the main body 10 is a convex face.

Referring to FIG. 7, the friction face 21 is only formed on the operation end 11 on one of the two ends of the main body 10. The friction face 21 is provided on a partial surface of the six faces 12 and a partial surface of the end face 13. The other one of the two ends of the main body 10 is not provided with the friction face 21.

Accordingly, the hex wrench structure of the present invention has the following advantages.
1. The friction face 21 increases the friction force between the operation end 11 and the workpiece when contacting, to prevent the workpiece from slipping from the operation end 11.
2. The surface of the operation end 11 is provided with the laser body 20 with the friction face 21. When the workpiece produces burrs, the laser body 20 on the main body 10 is used as a grinding tool to remove the burrs on the workpiece without having to use or purchase a sander, thereby saving the working time.
3. When the operation end 11 contacts an oily liquid, such as engine oil, lubricating oil, etc., in the workplace, the operation end 11 easily slips from the workpiece, thereby causing inconvenience to the operator. The friction face 21 is made by the laser process and provides an anti-slip function to increase the friction resistance during operation of the operation end 11.
4. The friction face 21 of the laser body 20 is provided with colors, characters, or figures to increase identification of the operation end 11.
5. The operation end 11 is provided with the friction face 21 so that the hex wrench structure has the maximum friction force.
6. The friction face 21 is provided on the main body 10 through a predetermined path set by a program. The laser body 20 is made by a conventional method. Thus, the main body 10 is provided with the laser body 20 to decrease the cost of fabrication.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the scope of the invention.

1. A hex wrench structure comprising:
a main body; and
a laser body mounted on the main body;
wherein:
the main body has an L-shaped profile;
an operation end is provided on at least one end of the main body;
the operation end is a surface contacting another element;
the operation end is a surface contacting a workpiece;
the operation end is a surface for rotating a workpiece;
the operation end is provided with six faces;
the operation end is provided with an end face;
the six faces surround the end face;
the end face has a planar shape;
the operation end of the main body is provided with a chamfered corner;
the chamfered corner is located between the six faces and the end face;
the chamfered corner has a circular shape;
the operation end is provided with an axis;
the six faces are arranged in an annular shape around the axis;
the laser body is mounted on the operation end;
the laser body is formed on a whole surface or a partial surface of the operation end by a working machine during a laser process;
a laser light is applied on the operation end;
the whole surface or partial surface of the operation end is provided with a friction face formed by the laser process, including peeling, coloring, concentration, or carbonization;
the friction face is a rough surface with particles;
the friction face increases a contact friction force between the operation end and the workpiece to prevent the workpiece from slipping from the operation end;
the operation end is provided with the laser body;
the friction face of the laser body is formed by the laser process;
multiple friction faces are provided on the partial surface of the operation end;
the friction faces are arranged on a partial surface of the six faces;
the friction faces are arranged on a partial surface of the chamfered corner;
the friction faces are arranged in an annular shape around the axis;
the end face is not provided with the friction faces;
the friction faces are arranged obliquely relative to the operation end;
an angle is defined between each of the friction faces and the axis;
the angle is ranged between ten (10) degrees and seventy (70) degrees, or ranged between fifteen (15) degrees and sixty (60) degrees;
the angle is optimally close to thirty (30) degrees;
each of the friction faces has a size relative to the operation end;
the size is a length perpendicular to the axis;
the size is more than ten millimeters (10 mm);
the friction faces are arranged linearly relative to the axis so that the friction faces and the axis are parallel mutually; and
the friction faces are arranged transversely relative to the axis so that the friction faces surround the axis and are arranged linearly in a direction of the axis.

2. The hex wrench structure as claimed in claim 1, wherein the operation end is provided on two ends of the main body, and each of the six faces has a planar shape.

3. The hex wrench structure as claimed in claim 1, wherein:
the laser body is provided on a surface of the operation end;
the friction face is served as the surface of the operation end; and
the friction face covers at least one third (⅓) of the surface of the operation end.

4. The hex wrench structure as claimed in claim 1, wherein:
each of the six faces of the operation end on one of the two ends of the main body has a planar shape;
each of the six faces of the operation end on the other one of the two ends of the main body is a convex face having a planar middle;
each of the six faces includes a first arcuate face connecting a plane connecting a second arcuate face; and
the chamfered corner has an oblique shape.

5. The hex wrench structure as claimed in claim 1, wherein each of the six faces of the operation end on each of the two ends of the main body is a convex face.

6. The hex wrench structure as claimed in claim 1, wherein:
the friction face is only formed on the operation end on one of the two ends of the main body;
the friction face is provided on a partial surface of the six faces and a partial surface of the end face; and
the other one of the two ends of the main body is not provided with the friction face.
